(19) United States
(12) Patent Application Publication
(10) Pub. No.: US 2003/0000553 A1
(43) Pub. Date: Jan. 2, 2003

(54) Device and method for cleaning golf balls

(76) Inventor: Michael John Murray, Yellow Rock (AU)

Correspondence Address: BRINKS HOFER GILSON & LIONE, SUITE 3600, N B C TOWER, 455 NORTH CITYFRONT PLAZA DR., CHICAGO, IL, 60611, US

(21) Appl. No.: 10/108,653

(22) Filed: Mar. 28, 2002

(30) Foreign Application Priority Data
Mar. 29, 2001 PCT/AU01/00351

(51) Int. Cl. B08B 3/04

(52) U.S. Cl. 134/33

(57) ABSTRACT

A cap (10) adapted for detachable attachment to a nozzle end (30) of an aerosol can, the cap (10) having a receptacle (22) for receiving a golf ball, the receptacle (22) being adapted such that when said receptacle (22) has a golf ball therein and said cap (10) is attached to said aerosol can nozzle end (30), the receptacle (22) is in communication with a nozzle (32) of the aerosol can and the golf ball is freely rotatable within the receptacle (22).

### FIELD OF THE INVENTION

The present invention relates to a device and method for cleaning golf balls.

### BACKGROUND OF THE INVENTION

When playing golf, soil and grass particles adhere to the surface of a golf ball after hitting the golf ball with a golf club and when the ball lands on the ground surface. These particles are typically cleaned off the ball surface by the use of a towel or brush in order to avoid any adverse effects on the flight or rolling characteristics of the ball. On occasion, it may be necessary to use a cleaning fluid to sufficiently clean the golf ball. Such cleaning fluids are not normally readily available on golf courses and the rotary type devices randomly placed around golf courses, more often than not, contain water only. Further, these rotary devices are only of use when in the golfer's immediate vicinity.

It is the object of the present invention to provide an improved device and method for cleaning golf balls.

### SUMMARY OF THE INVENTION

In one aspect, the present invention provides a cap adapted for detachable attachment to a nozzle end of an aerosol can, the cap having a receptacle for receiving a golf ball, the receptacle being adapted such that when said receptacle has a golf ball therein and said cap is attached to said aerosol can nozzle end, the receptacle is in communication with a nozzle of the aerosol can and the golf ball is freely rotatable within the receptacle.

In one form, the cap is formed as a unitary piece having an open end adapted for detachable attachment to the aerosol can nozzle end and the receptacle is a chamber formed inside of said cap. In this embodiment, the cap may include a rim formed adjacent the chamber, the rim having a width slightly less than the diameter of a golf ball, the golf ball being insertable into the chamber by elastic yielding of the rim.

In another embodiment, the cap includes a first section and a second section pivotable with respect to the first section, the first section having first and second open ends, the first open end being adapted for detachable attachment to the aerosol can nozzle end, the cap second section being pivotable with respect to the first section between an open position and a closed position at which the second section substantially closes the first section second end, said receptacle being a chamber formed inside said first and second sections at said closed position.

In the embodiments above, the cap preferably includes a nozzle aperture which allows access to the nozzle of the aerosol can for actuation thereof when said cap is attached to said aerosol can nozzle end. Alternatively, the cap may include an actuator arranged therein which is actuatable to actuate the nozzle of said aerosol can when said cap is attached to said aerosol can nozzle end.

In the preferred embodiment, the cap includes a first section and a second section, the first section having first and second open ends, the first open end being adapted for detachable attachment to the aerosol can nozzle end, the nozzle of the aerosol can extending through said first section second end when the cap is attached to the aerosol can, and wherein said second section forms the receptacle.

In this embodiment, the cap preferably includes a means for aligning the nozzle of the aerosol can relative to the receptacle when the cap is attached to the aerosol can. The aligning means may be a protruding portion of said first section second end. The cap second section is preferably pivotable with respect to the first section between an open position, at which the second section forms the receptacle, and a closed position, at which the second section substantially closes the first section second end.

In the above embodiments, the receptacle is preferably adapted such that when it receives a golf ball and said cap is attached to an aerosol can, the receptacle positions the golf ball in offset relation to a discharge axis of the nozzle. The cap may also include a discharge aperture for discharge of aerosol. The cap may also include internal bristles arranged within the receptacle for engaging the golf ball. Additionally, the cap may include external bristles arranged on an external surface thereof.

In another aspect, the present invention provides a golf ball cleaning device comprising:

an aerosol can having an actuatable dispensing nozzle at a nozzle end;

a cleaning fluid housed in said aerosol can and dispensable through said nozzle; and

a cap as above detachably attached to said aerosol can nozzle end.

In another aspect, the present invention provides a method for cleaning a golf ball using an aerosol can having a nozzle at a nozzle end which is actuatable for dispensing a cleaning fluid, and a cap having a receptacle, the cap adapted for detachable attachment to the aerosol can nozzle end, the method comprising the steps of:

(a) inserting a golf ball into the receptacle;

(b) attaching the cap to the aerosol can nozzle end; and

(c) actuating the aerosol can nozzle to dispense the cleaning fluid from the can, the stream of cleaning fluid rotating the golf ball within the receptacle such that the golf ball is engaged by the cleaning fluid.

In one embodiment, step (b) is performed before step (a).

### DESCRIPTION OF THE DRAWINGS

Preferred forms of the present invention will now be described, by way of examples only, with reference to the accompanying drawings wherein:

FIGS. 1(a) to (d) show respectively (a) perspective, (b) rear, (c) top, and (d) side views of a cap in accordance with a first embodiment of the present invention;

FIGS. 1(e) and (f) show respectively (e) perspective and (f) side views of the first embodiment attached to a first embodiment of an aerosol can nozzle end;

FIG. 2 shows a cap in accordance with a second embodiment of the present invention attached to a second embodiment of an aerosol can;

FIGS. 3(a) to (d) show respectively (a) perspective, (b) bottom end, (c) first side and (d) second side (first side view rotated by 90°) views of a cap in accordance with a third embodiment of the present invention;

FIG. 4 shows a cap in accordance with a fourth embodiment of the present invention attached to a third embodiment of an aerosol can; and

FIG. 5 shows a cap in accordance with a fifth embodiment of the present invention attached to the third embodiment of the aerosol can.

### DETAILED DESCRIPTION OF THE PREFERRED EMBODIMENTS

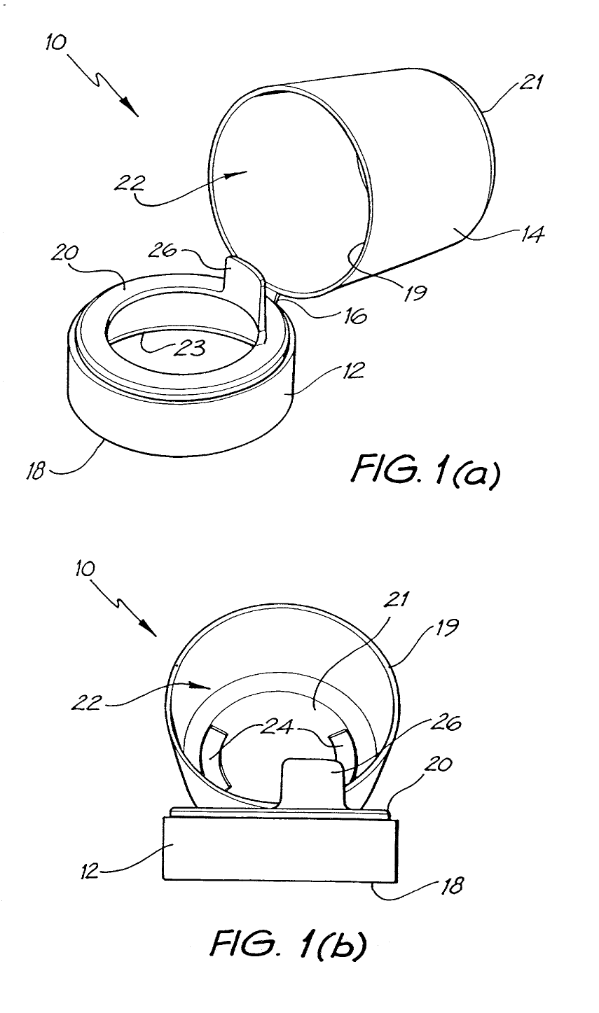

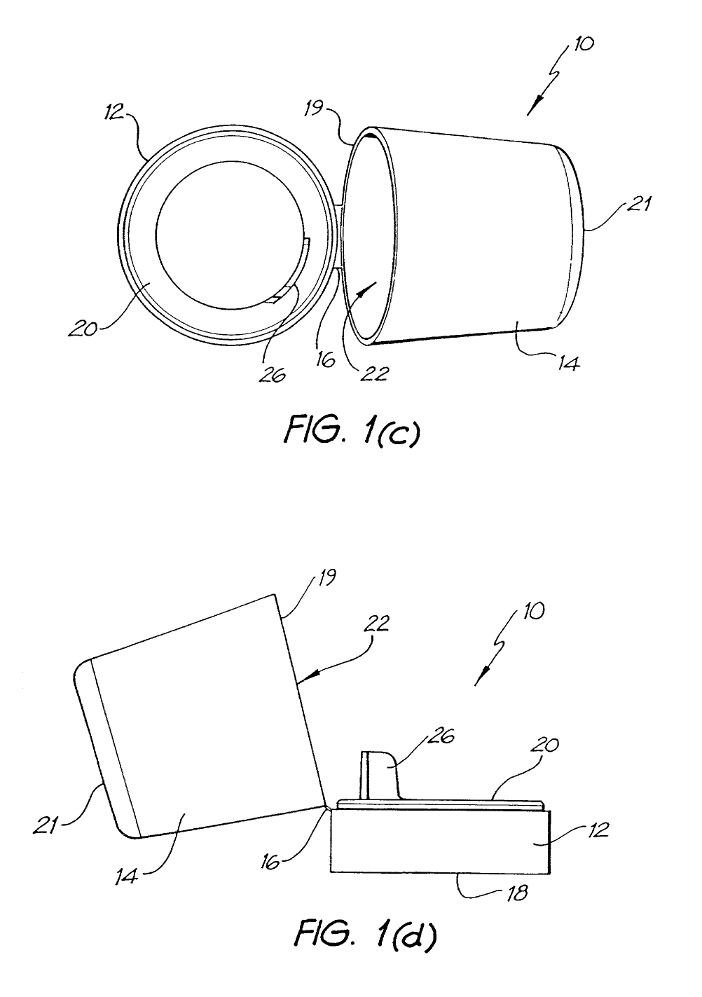

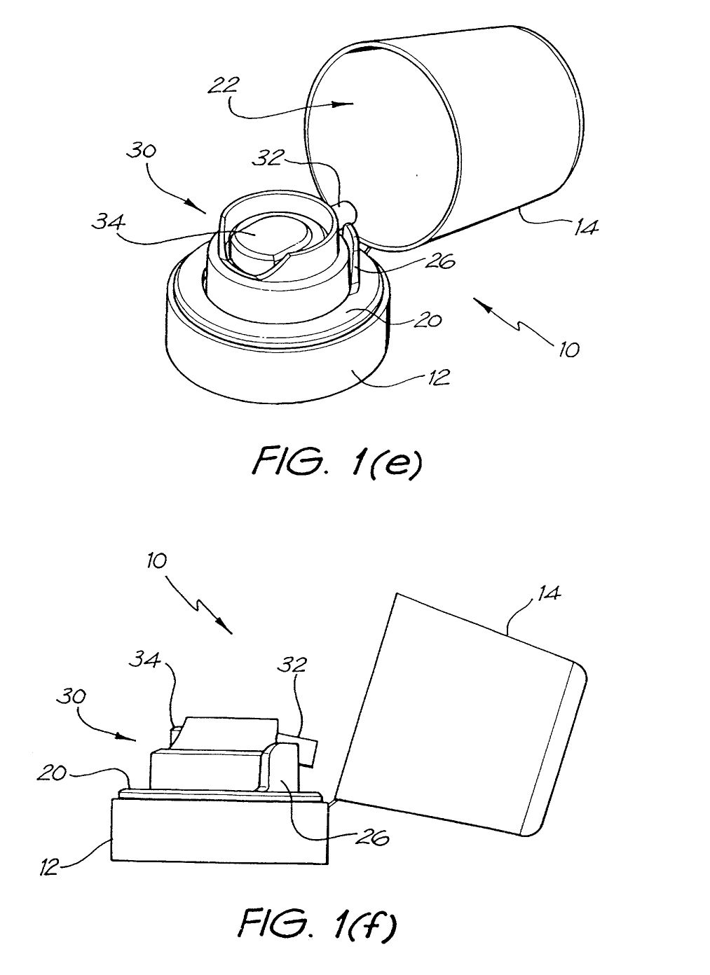

FIGS. 1(a) to (d) shows respectively (a) perspective, (b) rear, (c) top, and (d) side views of a cap 10 in accordance with a first embodiment of the present invention. The cap 10 includes a first section 12 in the form of a mounting ring, and a second section 14 in the form of an elongated lid. The mounting ring 12 is pivotally attached to the lid 14 via a hinge 16. The mounting ring 12 has a first lower open end 18 and a second upper open end 20. The lower end 18 is adapted for detachable attachment to a nozzle end of an aerosol can, via conventionally known means, such as those used for detachable attachment of cover caps to aerosol cans. This can include an inwardly protruding rib 23 adjacent the lower end 18, for engagement with a recess of the nozzle end of the aerosol can. The lid 14 has a first lower open end 19 and a second upper generally closed end 21.

The lid 14 forms a receptacle 22 therewithin, which is sized to receive a golf ball such that the golf ball is freely rotatable therein when the lower end 18 of the mounting ring 12 is attached to the aerosol can nozzle end. As golf balls typically have a diameter of 42.5 to 43.7 mm, receptacle 22 should have a diameter of around 45 mm or larger to ensure free rotation of the golf ball. The lid 14 also includes discharge apertures 24 formed in the closed end 21 for the discharge of aerosol. The mounting ring 12 includes an alignment protrusion 26 formed at the upper end 20, the use of which will be described below.

The lid 14 is pivotable with respect to the mounting ring 12 between an open position as shown in FIGS. 1(a) to (d), at which the lid 14 forms the receptacle 22, and a closed position, at which the lower end 19 of the lid 14 abuts the upper end 20 of the mounting ring 12. The lid 14 thus substantially closes the mounting ring upper end 20 at the closed position. The closed position is used to protect the aerosol can nozzle from accidental discharge, such as when in transport.

FIGS. 1(e) and (f) show respectively (e) perspective and (f) side views of the cap 10 attached to an aerosol can nozzle end 30, which has a nozzle 32 and a nozzle actuator 34. The body of the aerosol can is not shown for simplicity, but as well known, extends downwardly from the nozzle end 30. As shown in FIGS. 1(e) and (f), the cap 10 is used in the open position. When the cap 10 is attached to the nozzle end 30, the nozzle 32 and actuator 30 extend through the mounting ring upper end 20. The user rotates the nozzle 32 or the cap 10 such that the nozzle 32 abuts the alignment protrusion 26. In this position, the receptacle 22 is in communication with the nozzle 32. Thus, when a golf ball (not shown) is inserted into the receptacle 22, the golf ball can be engaged by the aerosol (which preferably includes a cleaning fluid) inside the aerosol can upon actuation of the nozzle actuator 34. Discharged aerosol can then exit through discharge apertures 24.

The cap 10 is dimensioned such that the receptacle 22 positions a golf ball received therein in offset relation to the discharge axis of the nozzle 32. The alignment protrusion 32 ensures that discharged aerosol laterally strikes the golf ball, which causes the ball to rotate within the receptacle 22. Further, the user can adjust the angle of the lid 14 relative to the mounting ring 12 in the open position, to ensure optimum contact between discharged aerosol and the golf ball.

In the cap 10, the lid 14 is frustoconical in shape. It is not limited to this shape however and can be, for example, a cylindrical section. The cap 10 can be sized for attachment to any of various commercially available aerosol cans.

The hinge 26 is preferably adapted to retain the lid 14 in the open position or closed position when the cap is in that position, or the cap 10 can include any conventional locking means, such as tabs or clips (not shown), to retain the lid 14 in the open or closed position. The cap 10 may also include internal bristles (not shown) arranged within the receptacle 22 and external bristles (not shown) arranged on the closed end 21 of the lid 14.

The external bristles can be used manually to remove large particles of clay and soil from a golf ball prior to cleaning with the aerosol. The external bristles can also be used for cleaning golf club heads. The internal bristles are preferably of length and stiffness so as not to excessively restrict rotation of the golf ball.

The internal bristles are not essential to the cap 10 and may be omitted if they excessively hinder rotation of the golf ball.

The cap 10 can be made of any substance, but preferably polypropylene (APD 160 grade or similar polymer), which is a grade used predominantly in aerosol cover cap manufacture.

The aerosol comprises a cleaning solution and a propellant. The cleaning solution is preferably water-based, as water is a low cost solvent into which other co-solvents and surfactants will dissolve. Suitable cleaning additives include:

(a) Ethanol, which is useful in solubilizing green grass stains, of high enough vapour pressure to provide reasonably rapid evaporation, and of a chemical nature which lowers the freezing point of water to prevent “icing” inside the cap.

(b) Surfactants including:

(i) non-ionic types, including ethoxylated linear alcohols and ethoxylated alkyl phenols;

(ii) anionics, including alkyl aryl sulphonates and olefin sulphonates, sodium alkyl sulphates and sodium alkyl ether sulphates;

(iii) cationics, including quaternary ammonium compounds; and,

(iv) amphoterics, including cocamidopropyl betaines;

(c) Sodium polyacrylates which are useful in solubilizing clays and other soils;

(d) Silicone fluids to maintain ball shine and provide a low-friction surface on drying; and

(e) Other additives to ensure appropriate fragrance, viscosity, pH and stability of the formula.

The cleaning solution should be formulated to work on clays, grass and soils, without affecting any outer polymer coating of the golf balls. The cleaning solution will also assist in lowering the freezing point of water, thereby reducing the propensity of ice formation within the cap 10. The cleaning solution preferably evaporates at a rate faster than water alone, allowing quicker drying of the golf ball and the cap 10. More preferably, the cleaning solution has a high volatile content to minimise residue drying on a golf ball and thus affecting its weight and in-flight properties. Further, the cleaning solution should not cause internal corrosion of the aerosol can and the interior side of the valve cup. Any surfactants used should be biodegradable. In relation to the cleaning fluid, preference should be given to naturally derived solvents.

Any known propellant which is compatible with the cleaning solution can be used. The propellant should be of sufficient pressure to not only propel the cleaning solution, but also rotate a golf ball received in the cap 10. The propellant should be of sufficient quantity to last for the life of the aerosol product, not contravene any statutory or industry guidelines, non-toxic, and, where possible, not contravene any low Volatile Organic Components (VOC) legislation. Where possible, the propellant should be non-flammable. Possible suitable propellants include dimethyl ether, hydrocarbons, compressed nitrogen, compressed air, compressed carbon dioxide, Forane 134a (proprietary name for 1,1,1,2-tetrafluoroethane) or Forane 152a (proprietary name for 1,2-diflouoroethane). High pressure hydrocarbons carbons could also be used, including propane/butane blends to obtain pressures of up to 75 psi (0.52 MPa).

The combination of the cleaning solution and propellant should comply with government deceptive packaging regulations, and the aerosol generally should comply with Australian Standard AS 2278-2000 and any subsequent issues or additions.

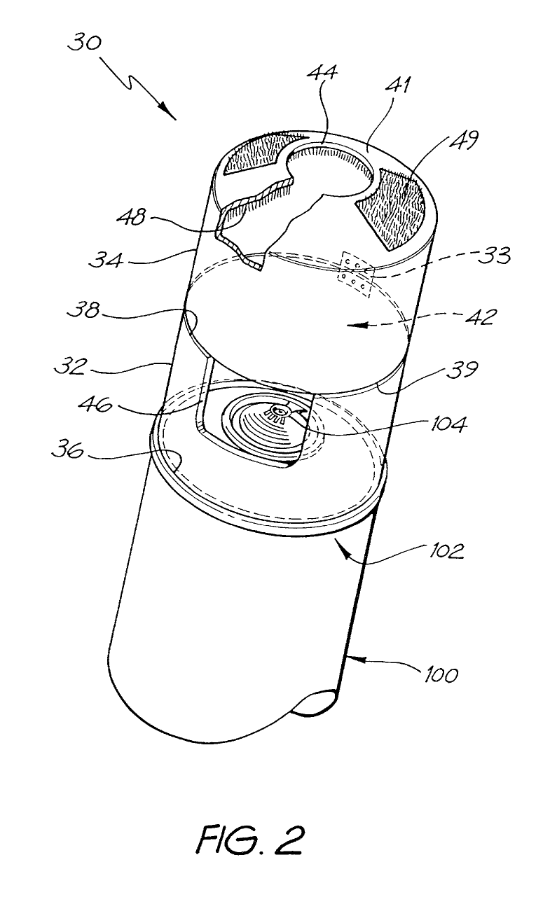

FIG. 2 shows a cap 30 in accordance with a second embodiment of the present invention attached to a nozzle end 102 of an aerosol can 100. The cap 30 includes a first section 32 in the form of a mounting ring and a second section 34 in the form of a lid. The mounting ring 32 is pivotally attached to the lid 34 via a hinge 33. The mounting ring 32 has a first lower open end 36 and a second upper open end 38. The lower end 36 is adapted for detachable attachment to the aerosol can nozzle end 102. The lid 34 has a first lower open end 39 and a second upper generally closed end 41.

The lid 34 is pivotable with respect to the mounting ring 32 between an open position, at which the lid lower end 39 is angularly spaced from the mounting ring upper end 38, and a closed position, at which the ends 38 and 39 abut each other as shown in FIG. 2. The lid 34 thus substantially closes the mounting ring upper end 38 at the closed position.

The mounting ring 32 and lid 34 form a chamber 42 therewithin in the closed position of the cap. The chamber 42 is sized to receive a golf ball such that the golf ball is freely rotatable therein when the cap 30 is attached to the aerosol can nozzle end 102.

The lid 34 includes a discharge aperture 44 formed in the closed end 41 for the discharge of aerosol. The mounting ring 32 includes a nozzle aperture 46 which allows access to the nozzle 104 of the aerosol can 100 for actuation thereof when the cap 30 is attached to the aerosol can nozzle end 32. The cap 30 also includes internal bristles 48 arranged within the chamber 42 and external bristles 49 arranged on the lid closed end 41.

As with the cap 10, the hinge 33 is preferably adapted to retain the lid 34 in the closed position when the cap 30 is in that position, or the cap 30 can include any conventional locking means.

The nozzle 104 of the aerosol can 100 dispenses aerosol in a direction substantially in alignment with the axis of the aerosol can 100.

In use, the mounting ring 32 is attached to the can nozzle end 102. The lid 34 is pivoted to the open position via hinge 33. A golf ball (not shown) to be cleaned is then inserted inside the mounting ring 32 or the lid 34. The lid 34 is then pivoted to the closed position, at which the mounting ring 32 and lid 34 form the chamber 42 enclosing the golf ball. The chamber 42 locates the golf ball in dispensing relation to the nozzle 104 and allows the golf ball to be freely rotatable therewithin.

In operation, the nozzle 104 is actuated by a user via the nozzle aperture 46, which allows the user's finger to access the nozzle 104. Actuation of the nozzle 104 dispenses an aerosol from the aerosol can 100, with the stream of aerosol rotating the golf ball within the chamber 42, such that the golf ball is engaged by the aerosol. The internal bristles 48 can engage the golf ball when the ball is rotating in the chamber 42 to assist in the cleaning thereof. The discharge aperture 44 allows discharge of aerosol which has passed through the chamber 42.

To assist the rotation of a golf ball by the stream of aerosol, the chamber 42 may be offset in relation to the longitudinal axis of the cap 30 passing through the centre of the mounting ring lower end 36. This will locate a golf ball in offset relation to the axis of the stream of aerosol dispensed from the nozzle 104. Alternatively, the nozzle 104 can be adapted to discharge the aerosol at an angle in relation to the longitudinal axis of the cap 30.

As described above, the chamber 42 is dimensioned to receive any size golf ball whose dimensions are set and approved by the various Professional Golf Associations. In large diameter aerosol cans, which typically have a diameter greater than 53 mm, the cap 10 will correspondingly have a large diameter which provides a bigger chamber 42. The bigger chamber 42 allows a golf ball to rest slightly off-centre of the axis of the aerosol can 100, allowing a natural offset discharge of aerosol in relation to the golf ball. The aerosol can 100 will typically be tilted during use such that the golf ball rests on the mounting ring 32 and lid 34, to ensure the golf ball will be offset in relation to the aerosol discharged from the nozzle 104.

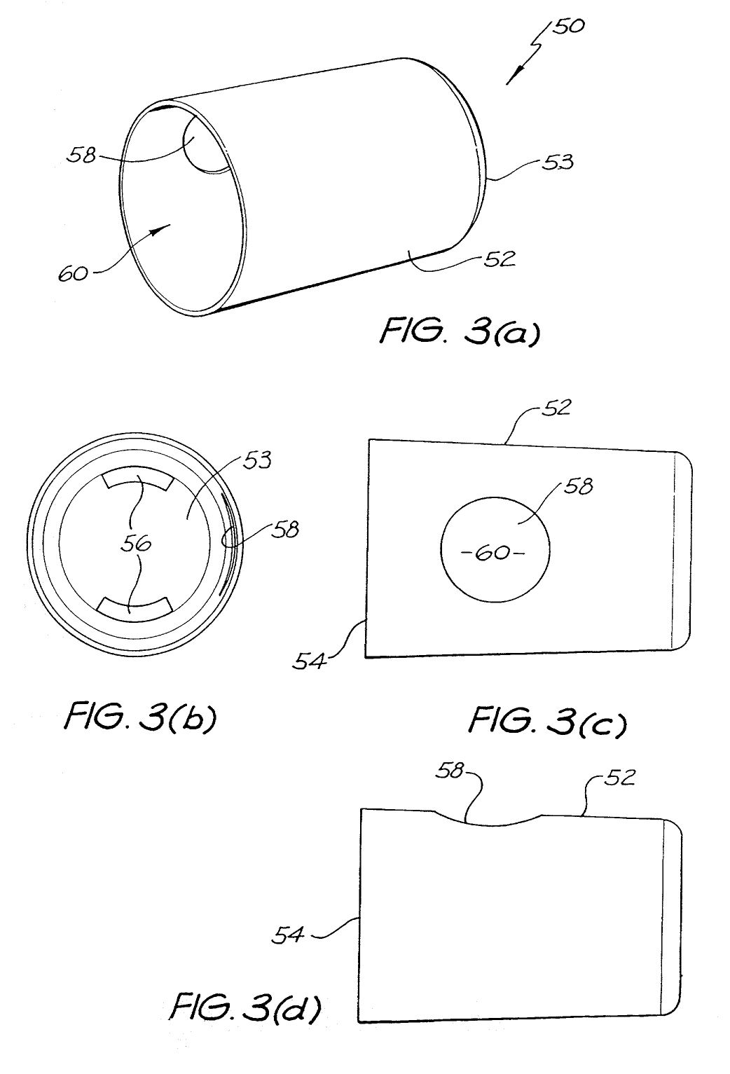

FIG. 3 shows several views of cap 50 in accordance with a third embodiment of the present invention. Cap 50 is formed as a unitary piece and includes a wall section 52, a top section 53, and an open end 54 opposite the top section 53. The open end 54 is adapted for detachable attachment to a nozzle end of an aerosol can. The top section 53 includes discharge apertures 56 and the wall section 52 includes a nozzle aperture 58. The cap 50 defines a chamber 60 therewithin which is in communication with the open end 54 and sized to receive golf ball. The cap 50 may also include internal bristles (not shown) arranged within the chamber 60 and external bristles (not shown) arranged on the top section 53.

In use, a golf ball (not shown) is inserted into the chamber 60 through open end 54. The open end 54 is then attached to a nozzle end of an aerosol can. The operator of the device then actuates the aerosol can through nozzle aperture 58, causing the golf ball to rotate and come in contact with the discharging aerosol contents as it spins within chamber 60.

In this embodiment, the wall section 52 is frustoconical in shape, having a larger cross-section at the open end 54 than at the top section 53.

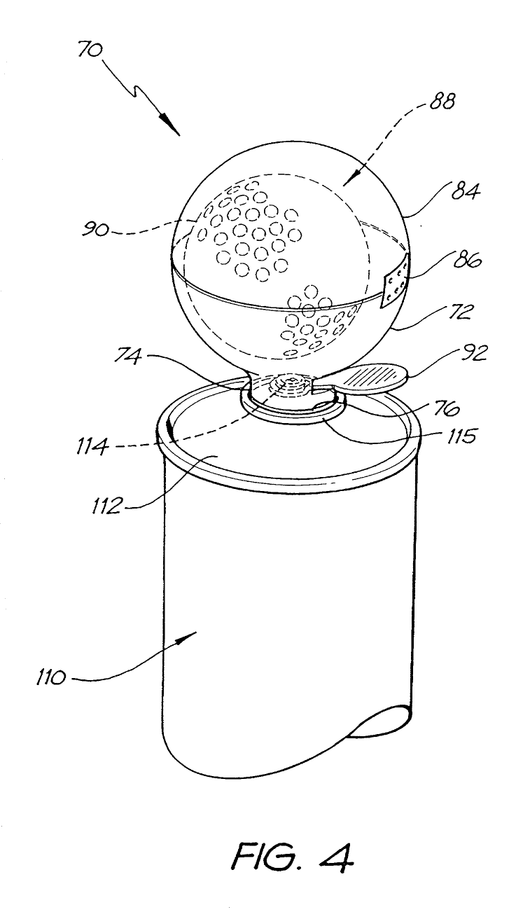

FIG. 4 shows a cap 70 in accordance with a fourth embodiment of the present invention attached to a third embodiment of an aerosol can 110. The third aerosol can 110 has a nozzle 114 at a nozzle end 112. The nozzle 114 has a crimped valve section 115, produced by conventionally known methods. The cap 70 includes a first section 72 having a connection stem 74. The connection stem 74 includes an open end 76 which is adapted for detachable attachment to the crimped valve section 115. The cap 70 also includes a second section 84 hingedly attached to the first section 72 via hinge 86. The second section 84 can be pivoted to an open position, at which the second section 84 is pivoted away from the first section 72, such that a golf ball 90 can be disposed inside the first section 72. The second section 84 can then be pivoted to a closed position such that the first and second sections 72 and 84 form a chamber 88 and enclose the golf ball 90 therewithin. The cap 70 includes an actuating lever 92 arranged in the connection stem 74, which is actuatable to actuate the nozzle 114.

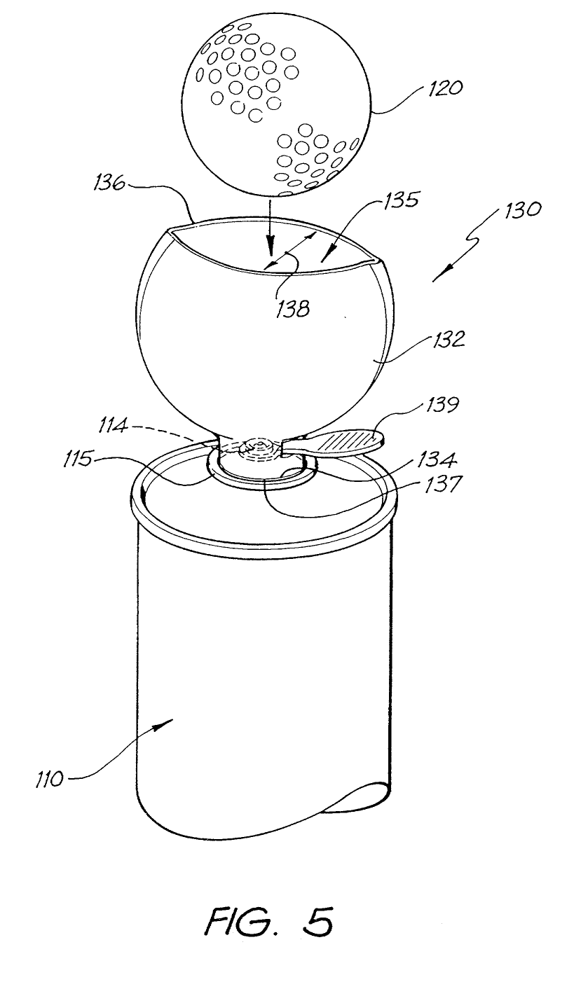

FIG. 5 shows a fifth embodiment of a cap 130 according to the present invention attached to the third aerosol can 110. The cap 130 includes a wall section 132 and a connection section 134 having an open end 137, which is adapted for detachable attachment to the crimped valve section 115.

The wall section 132 includes a rim 136 in the form of an open slit, opposite the open end 137. The rim 136 has a width dimension 138, typically about 40 mm, which is slightly less than the diameter of a golf ball 120. The wall section 132 is made of flexible resilient material such that the golf ball 120 can be forced into a chamber 135 defined within the wall section 132, by elastic yielding of the rim 136. An actuating lever 139 is arranged in the connection stem 134, which is actuatable to actuate the nozzle 114. The rim 136 also acts as a discharge aperture which allows discharge of aerosol which has passed through the chamber 135.

Although preferred embodiments of the cap have been described above, it will be apparent to persons skilled in the art that the cap can be embodied in other forms, or that modifications can be made to the preferred embodiments described above.

1. A cap adapted for detachable attachment to a nozzle end of an aerosol can, the cap having a receptacle for receiving a golf ball, the receptacle being adapted such that when said receptacle has a golf ball therein and said cap is attached to said aerosol can nozzle end, the receptacle is in communication with a nozzle of the aerosol can and the golf ball is freely rotatable within the receptacle.

2. The cap of claim 1 wherein the cap is formed as a unitary piece having an open end adapted for detachable attachment to the aerosol can nozzle end and the receptacle is a chamber formed inside of said cap.

3. The cap of claim 2 wherein the cap includes a rim formed adjacent the chamber, the rim having a width slightly less than the diameter of a golf ball, the golf ball being insertable into the chamber by elastic yielding of the rim.

4. The cap of claim 1 wherein the cap includes a first section and a second section pivotable with respect to the first section, the first section having first and second open ends, the first open end being adapted for detachable attachment to the aerosol can nozzle end, the cap second section being pivotable with respect to the first section between an open position and a closed position at which the second section substantially closes the first section second end, said receptacle being a chamber formed inside said first and second sections at said closed position.

5. The cap of any one of claims 1 to 4 wherein the cap includes a nozzle aperture which allows access to the nozzle of the aerosol can for actuation thereof when said cap is attached to said aerosol can nozzle end.

6. The cap of any one of claims 1 to 4 wherein the cap includes an actuator arranged therein which is actuatable to actuate the nozzle of said aerosol can when said cap is attached to said aerosol can nozzle end.

7. The cap of claim 1 wherein the cap includes a first section and a second section, the first section having first and second open ends, the first open end being adapted for detachable attachment to the aerosol can nozzle end, the nozzle of the aerosol can extending through said first section second end when the cap is attached to the aerosol can, and wherein said second section forms the receptacle.

8. The cap of claim 7 wherein the cap includes a means for aligning the nozzle of the aerosol can relative to the receptacle when the cap is attached to the aerosol can.

9. The cap of claim 8 wherein the aligning means is a protruding portion of said first section second end.

10. The cap of claim 7, 8 or 9 wherein the cap second section is pivotable with respect to the first section between an open position, at which the second section forms the receptacle, and a closed position, at which the second section substantially closes the first section second end.

11. The cap of any one of claims 1 to 4 and 7 to 9 wherein the receptacle is adapted such that when it receives a golf ball and said cap is attached to an aerosol can, the receptacle positions the golf ball in offset relation to a discharge axis of the nozzle.

12. The cap of any one of claims 1 to 4 and 7 to 9 wherein the cap includes a discharge aperture for discharge of aerosol.

13. The cap of any one of claims 1 to 4 and 7 to 9 wherein the cap includes internal bristles arranged within the receptacle for engaging the golf ball.

14. The cap of any one of claims 1 to 4 and 7 to 9 wherein the cap includes external bristles arranged on an external surface thereof.

15. A golf ball cleaning device comprising:
an aerosol can having an actuatable dispensing nozzle at a nozzle end;
a cleaning fluid housed in said aerosol can and dispensable through said nozzle; and
a cap as in any one of the preceding claims detachably attached to said aerosol can nozzle end.

16. A method for cleaning a golf ball using an aerosol can having a nozzle at a nozzle end which is actuatable for dispensing a cleaning fluid, and a cap having a receptacle, the cap adapted for detachable attachment to the aerosol can nozzle end, the method comprising the steps of:
(a) inserting a golf ball into the receptacle;
(b) attaching the cap to the aerosol can nozzle end; and
(c) actuating the aerosol can nozzle to dispense the cleaning fluid from the can, the stream of cleaning fluid rotating the golf ball within the receptacle such that the golf ball is engaged by the cleaning fluid.

17. The method of claim 16 wherein step (b) is performed before step (a).
